(19) United States
(12) Patent Application Publication
(10) Pub. No.: US 2011/0133372 A1
(43) Pub. Date: Jun. 9, 2011

(54) SELECTIVE SOLDERING APPARATUS AND A METHOD OF PUMPING SOLDER IN A SELECTIVE SOLDERING APPARATUS

(76) Inventor: Alexander James Ciniglio, Essex (GB)

(21) Appl. No.: 12/675,541

(22) PCT Filed: Aug. 22, 2008
(86) PCT No.: PCT/GB08/02883

§ 371 Date: Jul. 21, 2010

(30) Foreign Application Priority Data
Aug. 28, 2007 (GB) 0716698.6

(51) Int. Cl. B23K 31/02; B23K 1/08; B23K 3/06; B23K 3/08

(52) U.S. Cl. 266/44; 228/36

(57) ABSTRACT

An impeller type pump (7) in a selective soldering apparatus (1) is positioned so that the surface (S) level of molten solder in the bath adjacent the impeller axle (31) is just below the upper edge (53) of the impeller blades (41). This can reduce the formation of solder dust.

The present invention relates to a solder pump and in particular to a pump for a selective soldering apparatus.

It is well known to provide a selective soldering apparatus in which solder is pumped from a bath of molten solder to a nozzle outlet and component leads on a printed circuit board are dipped into the solder to solder them to the board printed circuit tracks. The solder may be pumped to over flow the nozzle outlet, returning to the solder bath. The pump speed may be varied to adjust the height of the solder at the nozzle outlet. It may be increased intermittently to clean or clear the solder surface at the nozzle outlet. It may also be reduced or stopped to lower the solder surface, for example to pull the solder away from the leads when withdrawing the leads from the solder.

Manufacturers require that soldering is performed in a nitrogen atmosphere, with very low oxygen content. This improves the quality of the solder joint and helps prevent the formation of dust or dross. Dust formation is a substantial problem as it results in large quantities of waste solder which must be recovered and can result in bad solder joints if it contaminates the solder flow. The formation of dust is exacerbated by pumping of the solder and its flow through the solder nozzle and back to the bath.

With large solder baths, the formation of dust can be tolerated for some time before it is necessary to clean the bath surface and/or replace the solder in the bath.

However, we provide a small bath which is particularly suitable for selective soldering operations in which the board is stationary and the bath is moved vertically and horizontally to solder the components to the board. With a small size bath it becomes especially important to minimise dust formation otherwise the bath must be cleaned at frequent intervals, resulting in significant down time of the soldering apparatus and the associated production line.

Another source of dust in solder baths is the shearing effect caused by the rotation of the impeller pump axle at the surface of the solder. In our application WO2005/115671, the contents of which are incorporated herein by reference, we describe a bearing sleeve which extends around the axle at the surface of the solder in the solder bath. With the advent of lead free solders in particular, many solder formulations must be kept at a higher temperature, at about 320° C. compared to 280° C. for lead containing solders. The higher temperature adversely affects the sleeve bearing, requiring it to be run at a grater clearance and hence leading to the possibility of greater dust formation.

The present invention provides a selective soldering apparatus comprising a solder pump having a radial blade impeller in an impeller pump chamber immersed in a bath of molten solder, wherein, in use, the surface of solder in the bath is below the upper level of the impeller pump blades. As the impeller rotates, it creates a vortex around the impeller axle. We believe this leads to less shearing at the solder surface and hence less dust formation.

Preferably the solder surface is within a few millimetres of the upper edge of the impeller blades when the pump is not running. Bearing in mind that when the pump is running the bath volume reduces slightly as solder fills the nozzle, the solder may be at or close to the upper edge of the blades prior to the pump running.

The impeller chamber has an inlet at its lower end for solder to enter the chamber.

The invention will be further described by way of example with reference to the accompanying drawings in which:

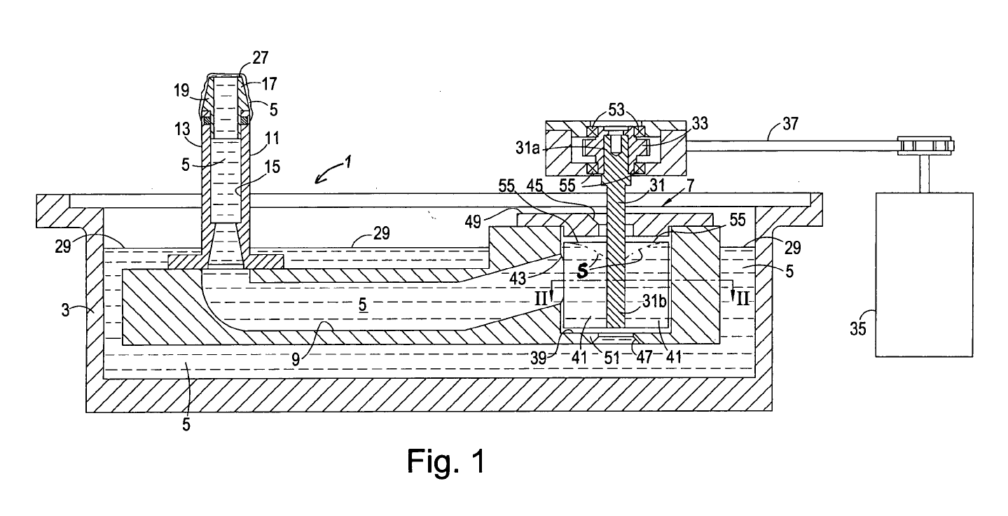

FIG. 1 is a cross-section through a soldering apparatus of the invention, and

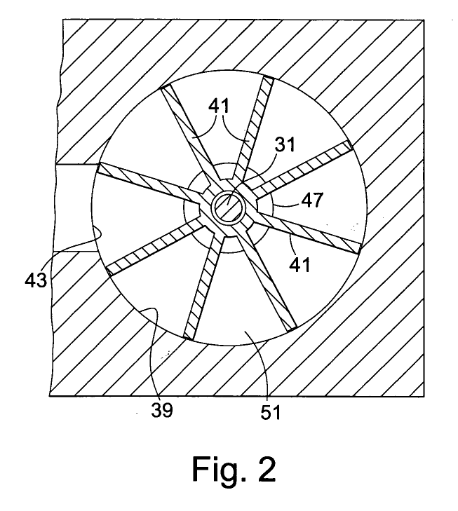

FIG. 2 is a cross section on line II-II of FIG. 1 through a pump chamber.

Referring to FIG. 1, a selective soldering apparatus 1 includes a bath 3 for containing molten solder 5. The solder 5 is heated by an electric heater (not shown) to be molten and held at a required temperature for soldering, typically about 300° C. An impeller type pump 7, which forms a particular feature of this invention and will be described in more detail hereinafter, is housed in the solder bath 3. The pump 7 pumps molten solder through a conduit 9 to a nozzle 11.

Nozzle 11 comprises a nozzle body 13 having an inner bore 15 fluidly connected to the conduit 9. A nozzle outlet 17 is formed by a removable iron tip 19 screwed into the end of the body 13. The nozzle tip 19 may also be a sliding fit and held in place by a detent or grub screw, for example.

In use, a cover, not shown, is provided over the bath 3 and extends up to just below the upper edge 27 of the outlet 17 to form an enclosure above the molten solder 5, so the space above the solder surface 29 can be purged with nitrogen gas. The nitrogen is fed below the cover in a manner well known in the art.

In use, the solder 5 is heated to its required soldering temperature. Nitrogen gas purges the space above the solder surface of air and in particular oxygen.

A dedicated nitrogen tube (not shown) may be provided to direct pre-heated nitrogen gas to a point just above nozzle outlet 17, so that pre-heated gas is directed to a joint which is about to be soldered.

After purging, nitrogen gas flow is continued and the pump speed increased to cause the solder to overflow the nozzle outlet 17. The solder runs down the outside of the nozzle back to the solder 5 in the bath 3. The soldering operation can commence, as well known in the art.

The arrangement thus far described is known in the art and described for example in WO2005/115671 and WO2005/115669.

Referring now to the pump 7, this comprises a drive axle 31 which is mounted in a pulley 33 at its upper end 31a supported in bearings 53, 55 and rotated by an electric motor 35 via a pulley belt 37. At the lower end 31 b of axle 31, radial impeller blades 41 are mounted and rotate in a cylindrical impeller pump chamber 39 to pump solder through a radial outlet 43 into conduit 9.

Chamber 39 has openings 45, 47 at its upper and lower ends 49, 51. Upper end 49 is formed by a removable cover on the chamber 39.

Heretofore, axle 31 has extended through the surface 29 of the solder 5 in the bath 3. We now arrange for the surface 29 of the molten solder 5 to be close to, and preferably just below, the upper edge 55 of the impeller blades 41. As a result of this, when the pump 7 is actuated, we believe a ‘vortex’ is created in the solder 5 at the region of the upper edge 55 of the blades 41. That is to say, the surface of the solder is lower at the centre of rotation of the impeller, i.e. the axle 31, and rises towards the outer edge of the impeller blades, as shown schematically by the dotted line S in FIG. 1. Surprisingly, we have found that this reduces the amount of solder dust produced by the pumping operation. It will be appreciated that the pump speed will affect the size of the vortex.

Solder is drawn into the pump chamber through the lower opening 47.

It will be appreciated that when the pump 7 is ‘off’ the height of solder in the bath is at a maximum and then drops slightly as the pump is started to pump solder through the nozzle 11. We prefer to arrange the surface of the molten solder in the bath proper, i.e. outside of the impeller chamber, with the pump operating, to be at or just below the upper edge 55 of the impeller blades. A height of about 5 mm above to 15 mm below the edge 55, and preferably 0 to 10 mm below the upper edge 55, is presently preferred.

1. A selective soldering apparatus comprising a solder bath containing solder, a solder pump having a radial blade impeller mounted on an axle which is rotated to operate the pump, an impeller pump chamber housing the impeller and having an outlet for solder to be fed from the pump, the axle extending into an upper end of the impeller chamber through an opening in the upper end, and another opening being formed in a lower end of the chamber below the impeller, wherein, in use, the level of solder in the bath adjacent the axle is at or below the upper edge of the impeller blade(s).

2. A soldering apparatus as claimed in claim 1, wherein, when the pump is not operational, the surface level of the molten solder in the bath level is between 5 mm above and 15 mm below the upper edge of the impeller blades.

3. A soldering apparatus as claimed in claim 2, wherein the solder surface level is between 0 mm above and 10 mm below the upper edge of the impeller blades.

4. A method of pumping solder in a selective soldering apparatus, the method comprising providing a radial bladed impeller pump and maintaining the solder level and the pump speed so that a vortex is created around the pump axle, the centre of the vortex being below the upper edge of the impeller blades.
